(19) United States
(12) Patent Application Publication
(10) Pub. No.: US 2025/0314673 A1
(43) Pub. Date: Oct. 9, 2025

(54) SAMPLE MEASURING APPARATUS

(71) Applicant: Konica Minolta, Inc., Tokyo (JP)

(72) Inventors: Hironao Miyamoto, Tokyo (JP); Yusuke Murakami, Tokyo (JP)

(73) Assignee: Konica Minolta, Inc., Tokyo (JP)

(21) Appl. No.: 19/097,107

(22) Filed: Apr. 1, 2025

(30) Foreign Application Priority Data
Apr. 3, 2024 (JP) 2024-060290

(51) Int. Cl. G01N 35/04

(52) U.S. Cl. CPC G01N 35/04; G01N 2035/0401; G01N 2035/0493

(57) ABSTRACT

Provided is a sample measuring apparatus including: a measuring instrument that measures a sample; a cassette capable of storing the plurality of samples including the sample; a conveyor that retrieves one of the plurality of samples from the cassette and conveys the one of the plurality of samples to the measuring instrument; and a contact avoidance section that avoids contact between the sample and a part of the cassette when the conveyor retrieves the one of the plurality of samples.

### CROSS-REFERENCE TO RELATED APPLICATIONS

The entire disclosure of Japanese Patent Application No. 2024-060290 filed on Apr. 3, 2024, is incorporated herein by reference in its entirety.

### BACKGROUND OF THE INVENTION

### Technical Field

The present invention relates to a sample measuring apparatus.

### Description of Related Art

Conventionally, a conveyance device that conveys a sample such as a thin substrate stored in a cassette to a next process is known (see Japanese Unexamined Patent Publication No. H10-120172). The conveyance device described in Japanese Unexamined Patent Publication No. H10-120172 includes a substrate-distance detecting device provided between two cassettes, a robot that moves a thin substrate upward, is capable of moving the thin substrate in the front-rear direction and the right-left direction, and is rotatable on the horizontal plane, and a controller that controls the robot.

The substrate distance detecting device is disposed so as to face a side surface of the thin substrate housed in each cassette, and has a first distance sensor. The first distance sensor is disposed at least at two positions in the front-rear direction in the vicinity of one side surface of the thin substrate housed in the cassette, and detects the distance from the side surface of the thin substrate.

The robot includes a second distance sensor capable of detecting a distance from the front surface of the thin substrate. The controller calculates a correction amount of a positional deviation and an angular deviation with respect to a predetermined position of the thin substrate based on detection results of the first distance sensor and the second distance sensor. Then, the controller moves the robot to the suction position of the thin substrate based on the calculated correction amount.

However, in the conveyance device described in Japanese Unexamined Patent Publication No. H10-120172, if the thin substrate is in contact with the inner wall of the cassette, a friction force is generated between the inner wall of the cassette and the thin substrate when the robot sucks and pulls out the thin substrate from the cassette. Therefore, there is a possibility that the thin substrate is displaced, the suction position of the robot is changed, or the thin substrate is removed from the suction of the robot. As a result, the thin substrate may not be arranged at the measurement position.

The present invention has been made in view of solving the above-described problem, and an object of the present invention is to provide a sample measuring apparatus capable of conveying a sample to a measurement position with high accuracy (precision).

### SUMMARY OF THE INVENTION

To achieve at least one of the abovementioned objects, according to an aspect of the present invention, a sample measuring apparatus reflecting one aspect of the present invention includes:
a measuring instrument that measures a sample;
a cassette capable of storing the plurality of samples including the sample;
a conveyor that retrieves one of the plurality of samples from the cassette and conveys the one of the plurality of samples to the measuring instrument; and
a contact avoidance section that avoids contact between the sample and a part of the cassette when the conveyor retrieves the one of the plurality of samples.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a schematic front view showing a configuration of a sample measuring device according to a first embodiment.

FIG. 2 is a schematic plan view showing a cassette and a position detector of the sample measuring apparatus according to the first embodiment.

FIG. 3 is a cross-sectional view taken along a line A-A in FIG. 1.

FIG. 4 is a block diagram showing a configuration of a control system of the sample measuring apparatus according to the first embodiment.

FIG. 5A is a diagram illustrating a shift of a sample which occurs in a case where the sample in contact with a side wall of the cassettes is pulled upward.

FIG. 5B is a diagram illustrating a shift of a sample which occurs in a case where the sample in contact with a side wall of the cassette is pulled upward.

FIG. 6A is a diagram illustrating a shift of a sample which occurs in a case where the sample in contact with a side wall of cassette is pulled out in a horizontal direction.

FIG. 6B is a diagram illustrating a shift of a sample which occurs in a case where the sample in contact with a side wall of the cassette is pulled out in a horizontal direction.

FIG. 7 is a flowchart showing a contact avoidance process performed by the controller according to the first embodiment.

FIG. 8 is a flowchart showing a contact avoidance process performed by the controller according to a second embodiment.

FIG. 9 is a front view showing a support portion of the cassette in the sample measuring apparatus according to a third embodiment.

### DETAILED DESCRIPTION

Hereinafter, one or more embodiments of the present invention will be described with reference to the drawings. However, the scope of the invention is not limited to the disclosed embodiments.

Hereinafter, embodiments of the present invention will be described in detail with reference to the drawings. In the present specification and drawings, elements having substantially the same function or configuration are denoted by the same reference numerals, and redundant descriptions of the constituent elements are omitted.

### First Embodiment

### [Configuration of Sample Measuring Apparatus]

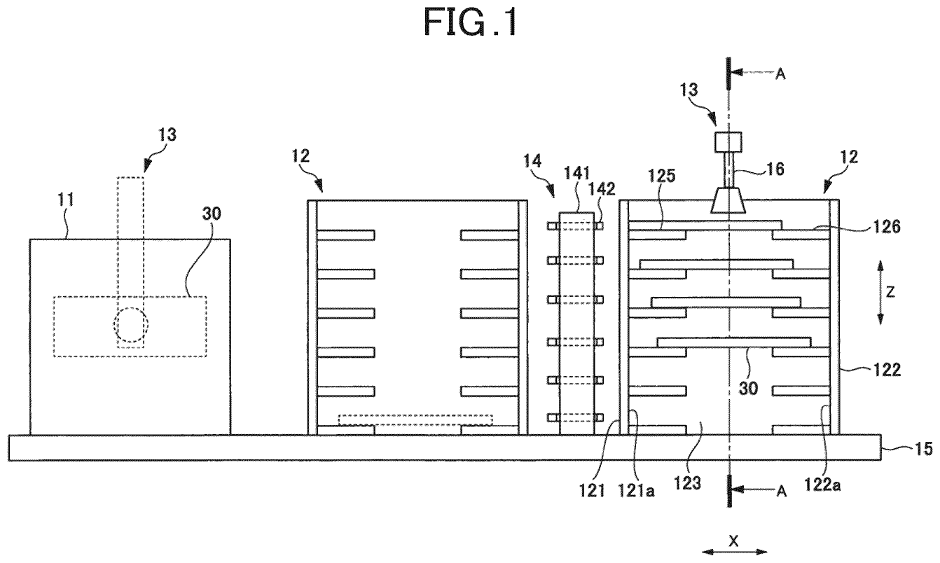

First, a configuration of a sample measuring apparatus according to a first embodiment will be described with reference to FIGS. 1 to 3.

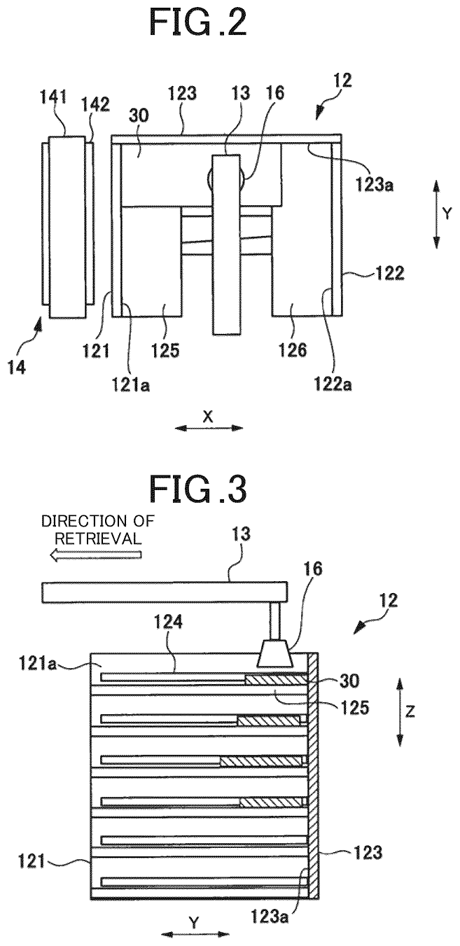

FIG. 1 is a schematic front view showing a configuration of a sample measuring device according to the first embodiment. FIG. 2 is a schematic plan view showing a cassette and a position detector of the sample measuring apparatus according to the first embodiment. FIG. 3 is a cross-sectional view taken along a line A-A in FIG. 1.

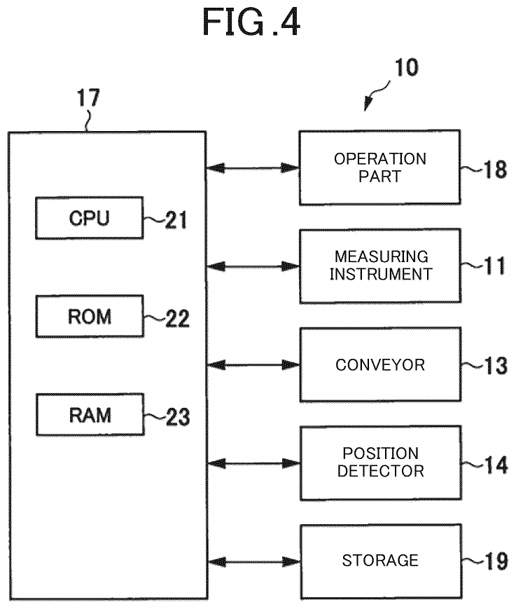

As shown in FIGS. 1 and 2, the sample measuring apparatus 10 includes a measuring instrument 11 for measuring the sample 30, a cassette 12, a conveyor 13, a position detector 14, and a controller 17 (hardware processor) (see FIG. 4). The measuring instrument 11, the cassette 12, the conveyor 13, and the position detector 14 are installed on a platform 15.

The cassette 12 can store a plurality of samples 30. The conveyor 13 retrieves a sample 30 from the cassette 12 and conveys the sample 30 to the measuring instrument 11. The position detector 14 detects the positions of the plurality of samples 30 stored in the cassette 12. The controller 17 controls the driving of the conveyor 13.

The measuring instrument 11 includes a measurement section. The measurement section measures the sample 30 for a predetermined measuring item. For example, if the measuring instrument 11 is a device that measures the surface state of the sample 30, the measurement section measures the surface state of the sample 30.

The surface condition of the sample 30 is at least one of the color, the surface properties, and the glossiness of the sample 30. The surface properties of the sample 30 are typically the surface roughness of the sample 30. In the present disclosure, as an example, the measuring instrument 11 is a device that measures the color of the sample 30, that is, a colorimeter. The sample 30 to be measured is disposed in a state in which the surface to be measured is close to and faces the measurement section of the measuring instrument 11.

The plurality of samples 30 having different sizes can be stored in one cassette 12. The sample 30 to be measured is typically a plate-like component. In the present disclosure, the shape of the sample 30 refers to the shape of the sample 30 when the plane of the sample 30 is viewed from the front, in other words, the shape of the sample horizontally placed in a plan view. In the present disclosure, as an example, a plate-like sample 30 having a quadrangular shape (e.g., a rectangle or a square) in plan view is a measurement target. The sample is formed of a material that does not substantially transmit visible light or the like, that is, an opaque material.

Here, the reason why the cassette 12 that can store a plurality of samples 30 having different sizes is used will be described.

In a case where only samples having the same size are stored in one cassette 12, it is necessary to prepare a dedicated cassette 12 for each size of the samples. Therefore, for example, even when 50 samples can be stored in one cassette 12, if at least one sample of a different size is included in the samples to be measured, the samples of different sizes must be stored separately in the two cassettes 12. As a result, the cassette 12 storing only one sample occupies the same area as a cassette capable of storing 50 samples, and the number of samples that can be mounted on the sample measuring apparatus 10 as a whole is reduced. In contrast, in a case of using the cassette 12 that can store a plurality of samples having different sizes, the above-described samples having different sizes can be collectively stored in one cassette 12 together with the other samples. Therefore, when the cassette 12 capable of storing a plurality of samples having different sizes is used, it is possible to increase the number of samples that can be mounted on the sample measuring apparatus 10 as a whole, compared to a case where only samples having the same size are stored in one cassette 12.

For the reasons described above, the cassette 12 that can store a plurality of samples having different sizes is used in the present disclosure.

The plurality of cassettes 12 is mounted on the platform 15. The plurality of cassettes 12 includes a first cassette 12 in which the samples 30 before measurement are stored and a second cassette 12 for storing the measured samples 30. Hereinafter, the sample 30 before measurement is also referred to as an “unmeasured sample 30”. The sample 30 which has been measured is also referred to as a “measured sample 30”.

The cassette 12 can store a plurality of samples in a state of being stacked at predetermined intervals in the vertical direction, that is, in a state of being arranged in a plurality of tiers (multiple stages) in the vertical direction. In each tier of the cassette 12, samples 30 are stored with a surface to be measured directed downward. The number of the cassettes 12 that can be placed on the platform 15 can be changed as necessary. In the present disclosure, a total of two cassettes 12, i.e., the first cassette 12 and the second cassette 12, are placed on the platform 15.

The conveyor 13 sequentially retrieves the samples from the specified first cassette 12 and conveys the samples to the measuring instrument 11. The conveyor 13 is constituted by a multi-axis robot. In the present disclosure, as an example, the conveyor 13 is formed by a six-axis robot. The six-axis robot as the conveyor 13 includes a kinesthetic sensor (six-axis kinesthetic sensor) (not illustrated).

The conveyor 13 includes a hand unit 16 for holding a sample. The hand unit 16 is disposed at an end of a six-axis robot constituting the conveyor 13. The hand unit 16 16 includes a vacuum generator and a suction pad. The suction pad is a rubber pad capable of sucking the sample 30. The suction pad is formed in a cylindrical shape. The vacuum generator causes the suction pad to generate a suction force for vacuum suction. The suction pad sucks a surface (hereinafter, also referred to as a “sucked surface”) of the sample 30 opposite to the surface to be measured.

The conveyor 13 holds the unmeasured samples 30 stored in the first cassette 12 one by one by the hand unit 16, and conveys the held sample toward a measurement position of the measuring instrument 11. Furthermore, the conveyor 13 arranges the sample 30 at the measurement position of the measuring instrument 11, and when the measurement of the color of the sample is completed in the measurement section, the conveyor 13 conveys the measured sample 30 toward the specified second cassette 12.

Hereinafter, in FIGS. 1 to 3, a width direction of the cassette 12 is defined as an X direction, a depth direction of the cassette 12 is defined as a Y direction, and a height direction of the cassette is defined as a Z direction. The samples 30 can be loaded into and unloaded from the cassette 12 in the horizontal direction (the depth direction Y). For this reason, the front side of the cassette 12 in the depth direction Y is opened for loading and unloading the samples 30. In the height direction Z of the cassette 12, a lower side is closed by the platform 15, and an upper side is opened so as not to interfere with (contact) the hand unit 16 of the conveyor 13.

The cassette 12 includes a pair of side plate portions 121 and 122 standing vertically on the platform 15, and a back plate portion 123 connecting the pair of side plate portions 121 and 122. The pair of side plate portions 121 and 122 face each other in the width direction X of the cassette 12. The back plate portion 123 is positioned on the far side in the depth direction Y of the cassette 12. The back plate portion 123 has substantially the same height as the pair of side plate portions 121 and 122. An inner surface 123a of the back plate portion 123 is arranged facing the front side (the lower side in FIG. 4) in the depth direction Y of the cassette 12.

Inner surfaces 121a and 122a of the pair of side plate portions 121 and 122 face each other in the widthwise direction X of the cassette 12. A plurality of support portions 125 is fixed to the inner surface 121a of the side plate portion 121. The plurality of support portions 126 is fixed to the inner surface 122a of the side plate portion 122. The plurality of support portions 125 and 126 are arranged at predetermined intervals in the height direction Z of the cassette 12.

In a case where the plurality of samples are stacked and stored in the plurality of tiers in one cassette 12, the plurality of support portions 125 and 126 support the samples in each tier. The support portions 125 and 126 supporting the samples at the same tier are at the same position in the height direction Z and face each other in the width direction X.

As shown in FIG. 2, the support portions 125 and 126 are formed in a flat plate shape elongated in the depth direction Y. Further, the support portion 125 is disposed so as to protrude from the inner surface 121a of the side plate portion 121 toward the center in the width direction of the cassette 12, and the support portion 126 is disposed so as to protrude from the inner surface 122a of the side plate portion 122 toward the center in the width direction of the cassette 12. The samples 30 accommodated in the cassette 12 are supported in a horizontal posture in a state where the end of the surface to be measured is placed on the pair of support portions 125 and 126.

As shown in FIG. 3, the side plate portions 121 and 122 have a plurality of detection windows 124. The plurality of detection windows 124 face side surfaces of the sample 30 supported by the support portions 125 and 126. The plurality of detection windows 124 are each formed in the shape of a slit that is long in the depth direction Y.

In the height direction Z, the bottoms of the plurality of detection windows 124 are located at a position higher than the upper surfaces of the opposed support portions 125 and 126 that support the samples 30. Furthermore, the length of the plurality of detection windows 124 in the height direction Z is shorter than the length of the sample 30 in the thickness direction. Thus, the sample 30 does not protrude to the outside of the cassette 12 from the detection window 124.

The support portions 125 and 126 of the present disclosure protrude from the inner surfaces 121a and 122a of the pair of side plate portions 121 and 122. However, the support portion according to the present disclosure may be a plurality of grooves that support the sample 30 on the inner surfaces 121a and 122a of the pair of side plate portions 121 and 122, respectively. That is, the cassette according to the present disclosure may have any configuration as long as a plurality of samples having different sizes can be stored.

As shown in FIGS. 1 and 2, the position detector 14 is disposed beside the first cassette 12. The position detector 14 faces, for example, the side plate portion 121 of the first cassette 12. The position detector 14 includes a frame 141 vertically standing on the platform 15 and a plurality of position detection sensors 142 attached to the frame 141.

The plurality of position detection sensors 142 are, for example, laser displacement meters. The plurality of position detection sensors 142 respectively face the plurality of detection windows 124 in the first cassette 12. The laser beam emitted from the position detection sensor 142 passes through the opposed detection window 124 and is irradiated onto the side surface of the sample 30.

The position detection sensor 142 receives the laser beam reflected by the side surface of the sample 30, and detects the position of the side surface of the sample 30 and the position of the sample 30 in the depth direction Y. The position detection sensor 142 transmits a measurement result to the controller 17 (see FIG. 4). The controller 17 detects the positions of the sample 30 in the width direction X and the depth direction Y from the measurement results of the position detection sensor 142.

The position detector 14 of the present disclosure includes a plurality of position detection sensors 142. However, the position detector according to the present disclosure may include one position detection sensor 142 and a movement mechanism that moves the one position detection sensor 142 in the height direction Z. In this case, the number of the position detection sensors 142 can be reduced.

The position detector according to the present disclosure may detect the position of not only the unmeasured sample 30 but also the sample 30 stored in the second cassette 12 (the measured sample 30). The detection result in this case is used by the controller 17 when the measured sample 30 is conveyed by the conveyor 13.

### [Configuration of Control System of Sample Measuring Apparatus]

Next, a configuration of a control system of the sample measuring apparatus 10 will be described with reference to FIG. 4.

FIG. 4 is a block diagram showing the configuration of the control system of the sample measuring apparatus 10.

As shown in FIG. 4, the sample measuring apparatus 10 includes a controller 17, an operation part 18, and a storage 19 in addition to the measuring instrument 11 and the conveyor 13 described above. The controller 17 includes, for example, as hardware resources of a computer, a central processing unit (CPU) 21, a read only memory (ROM) 22, and a random access memory (RAM) 23. The controller 17 comprehensively controls operation of the components of the sample measuring apparatus 10 as the CPU 21 reads a predetermined program from the ROM 22, develops it in the RAM 23, and executes the developed program.

Specifically, the controller 17 controls the operation of the conveyor 13 when the unmeasured sample 30 is taken out from the designated cassette 12, the operation of the measuring instrument 11 and the conveyor 13 when the sample 30 is measured, and the operation of the conveyor 13 when the measured sample 30 is accommodated in the designated cassette 12.

The operation part 18 functions as a user interface that displays various information to a user who uses the sample measuring apparatus 10 and receives input of various information from the user. The operation part 18 includes, for example, a display and an input section (not illustrated). The information input through the operation part 18 includes information on the samples 30 stored in the cassette 12. The information on the samples 30 includes information indicating the type of a sample 30, information indicating the size (including the shape) of a sample 30, information designating the cassette 12 in which an unmeasured (measurement target) sample 30 is stored, information designating the cassette 12 in which a measured sample 30 is to be stored, and the like. These pieces of information are input by a user operating the operation part 18 before starting the operation of the sample measuring apparatus described later.

The storage 19 is electrically connected to the controller 17, the position detector 14, and the measuring instrument 11. As the storage 19, a storage device such as a hard disk drive or a solid state drive, a storage area inside a computer, or a storage area on a network can be adopted. The storage 19 stores information necessary for the control of the conveyor 13 (position information and parameters necessary for operation), a measurement result of the position detector 14, a measurement result of the measuring instrument 11, and the like.

Furthermore, the storage 19 stores the types and storage positions of the samples. The type and the storage position of the samples 30 are, for example, information indicating that A-type samples are stored in the second to fifth tiers of the first cassette 12. Furthermore, the storage 19 stores size information of the sample 30 or an algebra derived from the size information.

[Malfunction when Sample is in Contact with Side Plate Portion of Cassette]

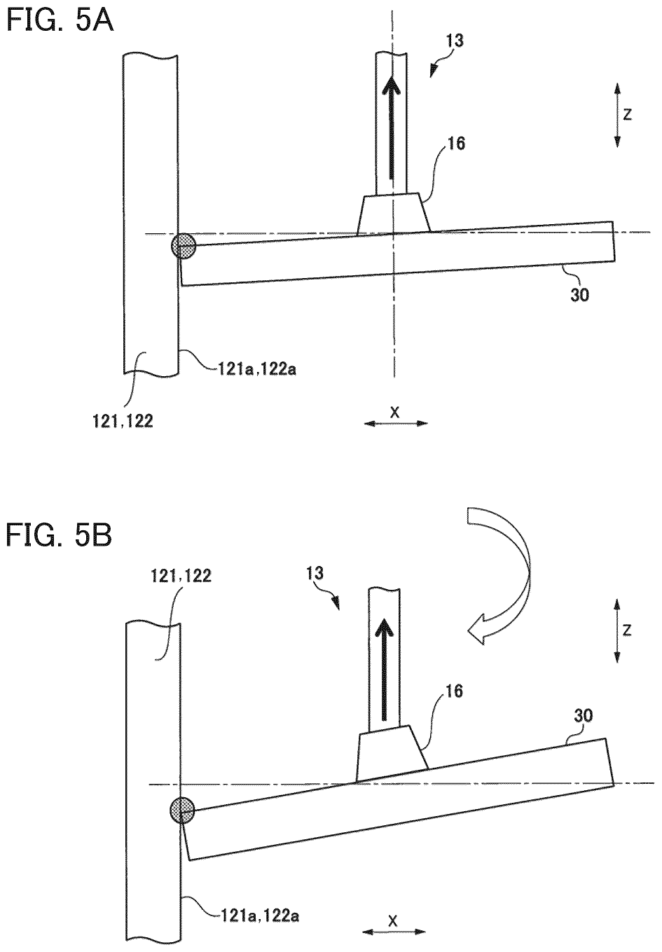

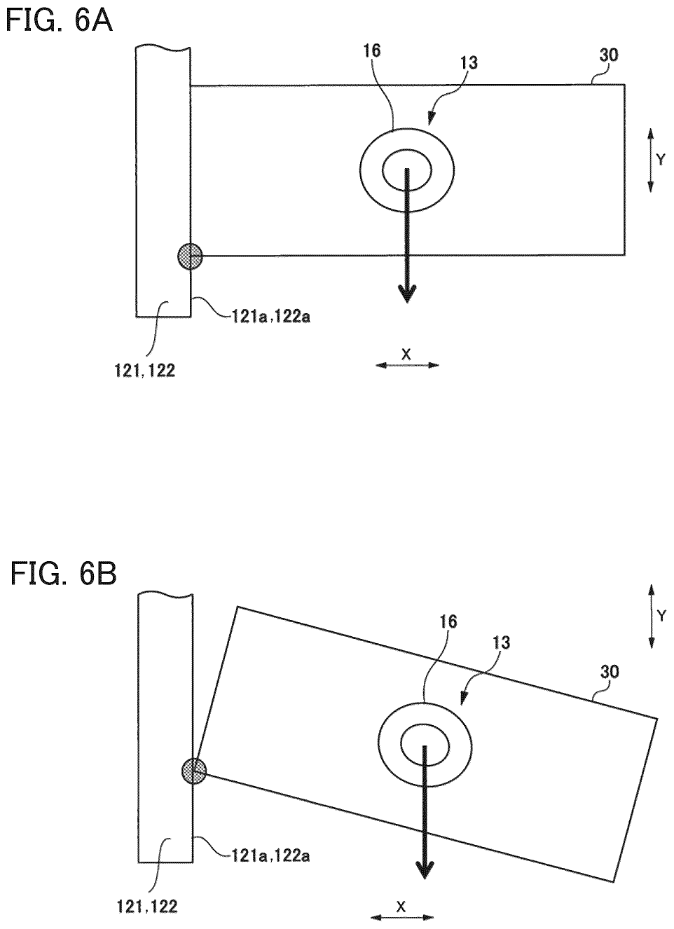

Next, a failure in a case where the sample 30 is in contact with the inner surface 121a, 122a of the side plate portion 121, 122 in the first cassette 12 will be described with reference to FIGS. 5 and 6.

FIGS. 5A and 5B each illustrate a shift of the sample 30 that occurs when the sample in contact with the side plate portion 121, 122 of the first cassette 12 is pulled upward. For example, as shown in FIG. 5A, when the side surface of the sample 30 is in contact with the inner surface 121a, 122a of the side plate portion 121, 122, the hand unit 16 of the conveyor 13 holding the sample 30 is moved upward. At this time, a force in a direction of rotating the sample 30 is generated in the sample 30 with the upper corner part of the side surface of the sample 30 as a fulcrum.

When the hand unit 16 is further raised from the state shown in FIG. 5A, the sample 30 rotates with the upper corner part in the side surface as a fulcrum, as shown in FIG. 5B. Thus, the position at which the hand unit 16 holds the sample 30 may be shifted.

FIGS. 6A and 6B each illustrate a shift of the sample 30 that occurs when the sample 30 in contact with the side plate portion 121, 122 of the first cassette 12 is pulled out horizontally. For example, as shown in FIG. 6A, when the side surface of the sample 30 is in contact with the inner surface 121a, 122a of the side plate portion 121, 122, the hand unit 16 holding the sample 30 is moved to the front side in the depth direction Y. At this time, a force is generated in the sample 30 in a direction in which the sample 30 is rotated with the near-side corner part of the side surface of the sample 30 as a fulcrum.

When the hand unit 16 is further moved to the near side from the state shown in FIG. 6A, the sample 30 rotates with a near-side corner part in the side surface as a fulcrum, as shown in FIG. 6B. Thus, the position at which the hand unit 16 holds the sample 30 may be shifted.

As described above, when the sample 30 is pulled out from the first cassette 12 in a state where the sample 30 is in contact with any part of the first cassette 12, the position at which the hand unit 16 holds the sample 30 may be shifted. When the position at which the hand unit 16 holds the sample 30 is shifted, a problem may occur in that the sample 30 cannot be accurately placed at the measurement position of the measuring instrument 11. In addition, when the shift of the sample 30 with respect to the hand unit 16 is large, the hand unit 16 may release its hold on the sample 30.

Therefore, in the present disclosure, when the sample 30 is in contact with the inner surface 121a, 122a of the side plate portion 121, 122, the sample 30 is moved in a direction away from the inner surface 121a, 122a of the side plate portion 121, 122 and then is raised or moved toward the front side. Whether or not the side surface of the sample 30 is in contact with the inner surface 121a, 122a of the side plate portion 121, 122 is determined by the controller 17 detecting the position in the width direction X of the sample 30 from the measurement result of the position detection sensor 142.

### [Sample Measurement Process]

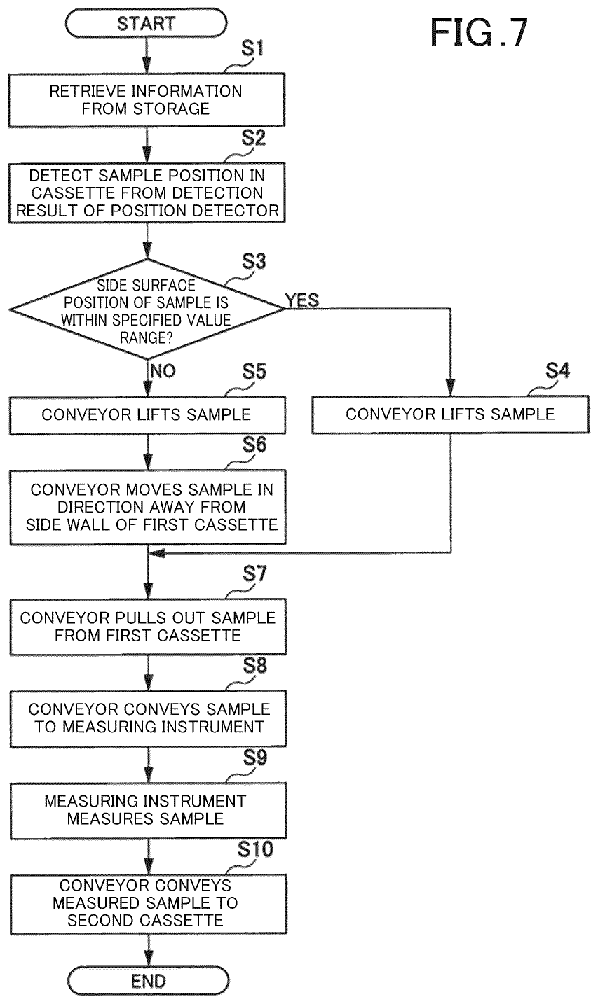

Next, the sample measurement process performed by the controller 17 will be described with reference to FIG. 7.

FIG. 7 is a flowchart showing a sample measurement process performed by the controller 17 according to the first embodiment.

First, the controller 17 retrieves information on the sample 30 to be measured from the storage 19 (S1). The information on the sample 30 includes information indicating the type of the sample 30 and information indicating the size (including the shape) of the sample 30. Next, the controller 17 detects the position of the sample 30 to be measured from the detection result of the position detector 14 (S2).

Next, the controller 17 determines whether or not the position of the side surface of the sample 30 to be measured is within a specified value range (S3). The specified value range is determined in advance in accordance with the size of the sample 30 and the size of the first cassette 12.

In a case where the position of the side surface of the sample 30 is within the specified value range, the side surface of the sample 30 is separated from the inner surfaces 121a and 122a of the side plate portions 121 and 122, and there is no possibility of contact thereafter. On the other hand, in a case where the position of the side surface of the sample 30 is outside the specified value range, the side surface of the sample 30 is in contact with or may subsequently contact the inner surface 121a of the side plate portion 121 or the inner surface 122a of the side plate portion 122.

In Step S3, when it is determined that the position of the side surface of the sample 30 is within the specified value range (YES in S3), the controller 17 controls the driving of the conveyor 13 to hold and lift the sample 30 (S4). Thus, the sample 30 is separated from the support portions 125 and 126 of the first cassette 12. After the processing of Step S4, the controller 17 proceeds to the processing of Step S7.

When it is determined in Step S3 that the position of the side surface of the sample 30 is out of the specified value range (NO in S3), the controller 17 controls the driving of the conveyor 13 to hold and lift the sample 30 (S5). Subsequently, the controller 17 controls the driving of the conveyor 13 to move the sample 30 in a direction away from the inner surface 121a, 122a of the side plate portion 121, 122 (S6). Thus, the position of the side surface of the sample 30 moves to within the specified value range.

After the processing of Step S6 or Step S4, the controller 17 controls the driving of the conveyor 13 to pull out the sample 30 from the first cassette 12 (S7). Subsequently, the controller 17 controls the driving of the conveyor 13 to arrange the sample 30 at the measurement position of the measuring instrument 11 (S8). Thereafter, the controller 17 controls the measuring instrument 11 to measure the surface state of the sample 30 (S9).

Next, the controller 17 controls the driving of the conveyor 13 to convey the measured sample 30 to the second cassette 12 that stores the measured samples 30 (S10). After the processing of Step S10, the controller 17 ends the sample measurement process.

The position detector 14 and the controller 17 of the first embodiment correspond to a contact avoidance section according to the present disclosure. The sample measuring apparatus 10 of the first embodiment detects the position of the sample 30 based on a detection result of the position detector 14. Next, when the sample 30 is in proximity to or in contact with the inner surface 121a, 122a of the side plate portion 121, 122, the sample 30 is moved in a direction away from the inner surface 121a, 122a of the side plate portion 121, 122.

The sample measuring apparatus 10 thereby avoids the sample 30 from being pulled out in a state of being in contact with the inner surface 121a, 122a of the side plate portion 121, 122 in the first cassette 12. As a result, the sample measuring apparatus 10 can prevent the position of the hand unit 16 holding the sample 30 from being shifted and convey the sample 30 to the measurement position of the measuring instrument 11 with high accuracy.

### Second Embodiment

The configuration of the sample measuring apparatus of the second embodiment is the same as that of the sample measuring apparatus 10 of the first embodiment. The sample measuring apparatus of the second embodiment is different from the sample measuring apparatus 10 of the first embodiment in the sample measurement process. Therefore, the sample measurement process according to the second embodiment will be described here, and descriptions overlapping with those of the sample measuring apparatus 10 of the first embodiment will be omitted.

When the hand unit 16 holds and lifts the sample 30, one end of the sample 30 in the width direction may hang down and a lower corner part of a side surface of the sample 30 may contact the upper surface of the support portion 125, 126. In this state, when the hand unit 16 holding the sample 30 is moved to the front side in the depth direction Y, a force in a direction in which the sample 30 is rotated is generated in the sample 30 with the lower corner part in the side surface of the sample 30 as a fulcrum. Thus, the position at which the hand unit 16 holds the sample 30 may be shifted.

Therefore, in the present disclosure, when one end of the sample 30 in the width direction hangs down, the position at which the hand unit 16 holds the sample 30 is changed, and then the sample 30 is raised or moved to the front side. Whether or not one end of the sample 30 in the width direction hangs down is determined by the controller 17 detecting, from the measurement result of the position detection sensor 142, a deviation between the position at which the hand unit 16 holds the sample 30 and the position of the center of gravity of the sample 30.

### [Sample Measurement Process]

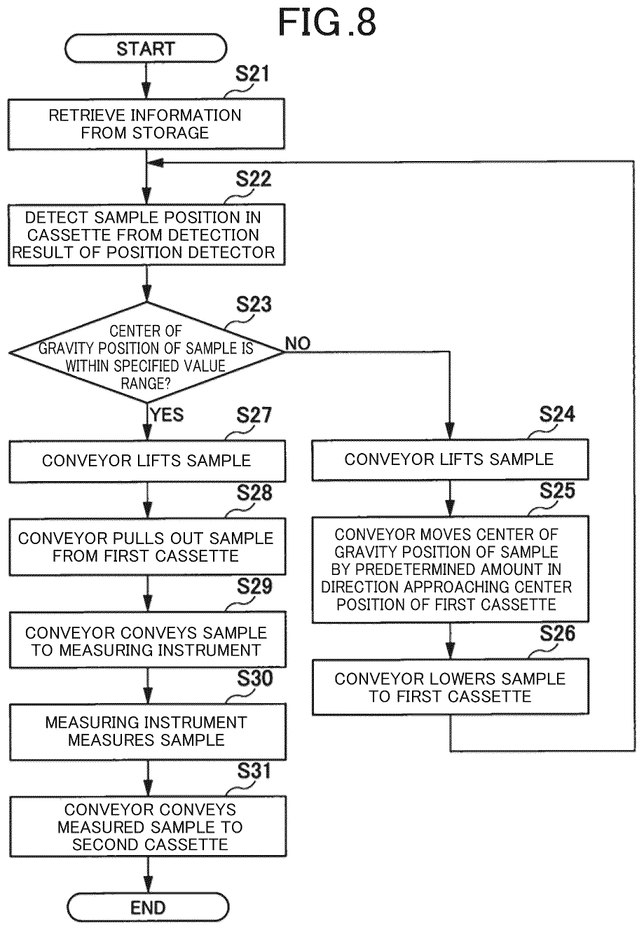

The sample measurement process performed by the controller 17 according to the second embodiment will be described with reference to FIG. 8.

FIG. 8 is a flowchart showing a sample measurement process performed by the controller 17 according to the second embodiment.

First, the controller 17 retrieves information on the sample 30 to be measured from the storage 19 (S21). Next, the controller 17 detects the position of the sample 30 to be measured from the detection result of the position detector 14 (S22). Next, the controller 17 determines whether or not the position of the center of gravity of the sample 30 to be measured is within a specified value range (S23). The specified value range is determined in advance in accordance with the size of the sample 30 and the size of the first cassette 12.

When the position of the center of gravity of the sample 30 is within the specified value range, the position at which the hand unit 16 holds the sample 30 is close to the position of the center of gravity of the sample 30. Therefore, one end of the sample 30 in the width direction hangs down by a small amount and is not likely to contact the support portions 125 and 126. On the other hand, when the position of the center of gravity of the sample 30 is outside the specified value range, the position at which the hand unit 16 holds the sample 30 is far from the position of the center of gravity of the sample 30. Therefore, there is a possibility that one end of the sample 30 in the width direction hangs down and comes into contact with the support portions 125 and 126.

When it is determined in Step S23 that the position of the center of gravity of the sample 30 is not within the specified value range (is outside the specified value range) (NO in S23), the controller 17 controls the driving of the conveyor 13 to hold and lift the sample 30 (S24). Next, the controller 17 controls the driving of the conveyor 13 to move the sample 30 by a predetermined amount in a direction in which the position of the center of gravity of the sample 30 approaches the central position of the first cassette 12 (S25).

Next, the controller 17 controls the driving of the conveyor 13 to lower the sample 30 and place the sample 30 on the support portions 125 and 126 (S26). After the processing of Step S26, the controller 17 returns to the processing of Step S22. That is, the controller 17 changes the position of the sample 30 relative to the first cassette 12 until the position of the center of gravity of the sample 30 is within the specified value range.

When it is determined that the position of the center of gravity of the sample 30 is within the specified value range in Step S23 (YES in S23), the controller 17 controls the driving of the conveyor 13 to hold and lift the sample 30 (S27). Next, the controller 17 controls driving of the conveyor 13 to pull out the sample 30 from the first cassette 12 (S28).

Subsequently, the controller 17 controls the driving of the conveyor 13 to arrange the sample 30 at the measurement position of the measuring instrument 11 (S29). Thereafter, the controller 17 controls the measuring instrument 11 to measure the surface state of the sample 30 (S30). Next, the controller 17 controls the driving of the conveyor 13 to convey the measured sample 30 to the second cassette 12 that stores the measured sample 30 (S31). After the processing of Step S31, the controller 17 ends the sample measurement process.

The position detector 14 and the controller 17 of the second embodiment correspond to the contact avoidance section according to the present disclosure. The sample measuring apparatus according to the second embodiment detects the position of the center of gravity of the sample 30 based on the detection result of the position detector 14. Next, when the position of the center of gravity of the sample 30 is not within the specified value range, the sample measuring apparatus moves the sample 30 by a predetermined amount in a direction in which the position of the center of gravity of the sample 30 approaches the center position of the first cassette 12, and changes the position at which the hand unit 16 holds the sample 30. That is, the sample measuring apparatus moves the position at which the hand unit 16 holds the sample 30 closer to the center of gravity of the sample 30.

The sample measuring apparatus of the second embodiment thereby avoids one end of the sample 30 in the width direction from hanging down and contacting the support portions 125 and 126. As a result, the sample measuring apparatus of the second embodiment can prevent the position of the hand unit 16 holding the sample 30 from being shifted, and can convey the sample 30 to the measurement position of the measuring instrument 11 with high accuracy.

In the second embodiment, the position at which the hand unit 16 holds the sample 30 is brought close to the center of gravity of the sample 30 by changing the position at which the sample 30 is placed. However, the sample measuring apparatus according to the present disclosure may bring the position at which the hand unit 16 holds the sample 30 close to the center of gravity of the sample 30 by changing the position at which the hand unit 16 holds the sample 30.

### Third Embodiment

The sample measuring apparatus of the third embodiment is different from the sample measuring apparatus 10 of the first embodiment in a support portion of the cassette. Therefore, the support portion of the cassette according to the third embodiment will be described here, and descriptions overlapping with those of the sample measuring apparatus 10 of the first embodiment will be omitted.

### [Support Portion of Cassette]

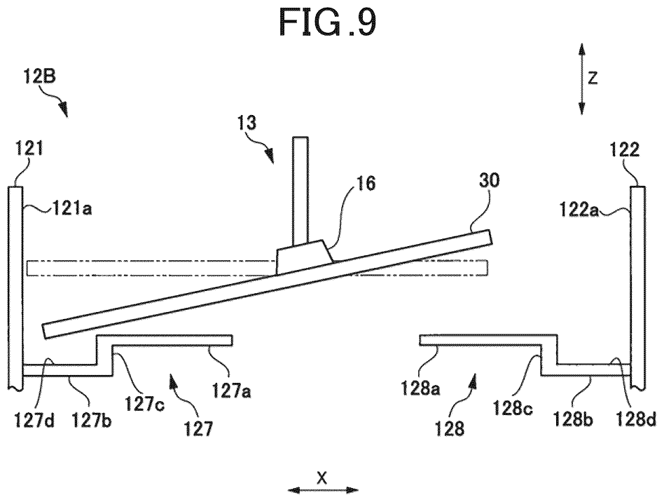

FIG. 9 is a front view showing a support portion of the cassette in the sample measuring apparatus according to the third embodiment. As shown in FIG. 9, a cassette 12B according to the third embodiment includes a pair of side plate portions 121 and 122 that vertically stands on the platform 15 (see FIG. 1), and a back plate portion (not illustrated) that connects the pair of side plate portions 121 and 122.

The pair of side plate portions 121 and 122 face each other in the width direction X of the cassette 12B. Inner surfaces 121a and 122a of the pair of side plate portions 121 and 122 face each other in the width direction X of the cassette 12B. A plurality of support portions 127 (one is shown in FIG. 9) are fixed to the inner surface 121a of the side plate portion 121. A plurality of support portions 128 (one is shown in FIG. 9) are fixed to the inner surface 122a of the side plate portion 122. The plurality of support portions 127 and 128 are arranged at predetermined intervals in the height direction Z of the cassette 12B.

When a plurality of samples are stacked and stored in a plurality of tiers in one cassette 12B, the plurality of support portions 127 and 128 support the samples in the respective tiers. The support portions 125 and 126 supporting the samples at the same tier are at the same position in the height direction Z and face each other in the width direction X.

The support portion 127 has an upper plate portion 127a and a lower plate portion 127b which are adjacent to each other in the width direction X, and a connecting portion 127a which connects the upper plate portion 127b and the lower plate portion 127c. The upper plate portion 127a is located at a position higher than the lower plate portion 127b in the height direction Z on the central side in the width direction X of the cassette 12B.

The lower plate portion 127b is located at a position lower than the upper plate portion 127a in the height direction Z on the side of the side plate portion 121 in the width direction X of the cassette 12B. Thus, a recessed part 127d is formed at an end of the support portion 127 close to the side plate portion 121. The recessed part 127d is formed in a shape of a quadrangle that is long in the depth direction Y when viewed from above.

The support portion 128 has an upper plate portion 128a and a lower plate portion 128b which are adjacent to each other in the width direction X, and a connecting portion 128a which connects the upper plate portion 128b and the lower plate portion 128c. The upper plate portion 128a is located at a position higher than the lower plate portion 128b in the height direction Z on the central side in width direction X of the cassette 12B and higher than.

The lower plate portion 128b is located at a position lower than the upper plate portion 128a in the height direction Z on the side of the side plate portion 122 in the width direction X of the cassette 12B. Thus, a recessed part 128d is formed at an end of the support portion 128 close to the side plate portion 122. The recessed part 128d is formed in a shape of a quadrangle that is long in the depth direction Y when viewed from above.

The recessed parts 127d and 128d described above correspond to the contact avoidance section according to the present disclosure. The recessed parts 127d and 128d avoid contact with the support portions 127 and 128 when one end of the sample 30 in the width direction held by the hand unit 16 hangs down. As a result, the sample measuring apparatus of the third embodiment can prevent the position of the hand unit 16 holding the sample 30 from being shifted, and can convey the sample 30 to the measurement position of the measuring instrument 11 with high accuracy.

The sample measuring apparatus of the present disclosure has been described above, including the operation and effects thereof. However, the sample measuring apparatus of the present disclosure is not limited to the above-described embodiments, and various modifications can be implemented within the scope not departing from the spirit of the invention described in the claims.

Furthermore, the above-described embodiments have been described in detail in order to explain the present disclosure so that they are easily understood, and the present invention is not necessarily limited to those including all of the described components. Furthermore, part of the configuration of an embodiment can be replaced with that of another embodiment, and the configuration of an embodiment can be added to that of another embodiment. Furthermore, it is also possible to add, delete, or replace another configuration for a part of the configuration of each embodiment. For example, the contact avoidance section in the above-described first to third embodiments can be simultaneously applied to one apparatus.

The position detector of the above-described embodiments detects the position of the sample 30 using the position detection sensor 142. However, the position detector according to the present disclosure may detect the position of the sample 30 using a camera or a kinesthetic sensor. Furthermore, the sample measuring apparatus according to the present disclosure may avoid contact of the sample 30 with the back plate portion 123 of the cassette 12 when the sample 30 is pulled out from the first cassette 12.

Although embodiments of the present invention have been described and shown in detail, the disclosed embodiments are made for purposes of illustration and example only and not limitation. The scope of the present invention should be interpreted by terms of the appended claims.

What is claimed is:

1. A sample measuring apparatus comprising:
a measuring instrument that measures a sample;
a cassette capable of storing a plurality of samples including the sample;
a conveyor that retrieves one of the plurality of samples from the cassette and conveys the one of the plurality of samples to the measuring instrument; and
a contact avoidance section that avoids contact between the sample and a part of the cassette when the conveyor retrieves the one of the plurality of samples.

2. The sample measuring apparatus according to claim 1,
wherein the contact avoidance section includes:
a position detector that detects a position of the sample in a direction in which the sample faces a side wall of the cassette;
a hardware processor that controls the conveyor;
wherein when the one of the plurality of samples and the side wall of the cassette are in contact with each other from a detection result of the position detector, the hardware processor controls the conveyor to perform an operation of moving the one of the plurality of samples held by the conveyor in a direction away from the side wall of the cassette and then retrieving the sample from the cassette.

3. The sample measuring apparatus according to claim 1,
wherein the contact avoidance section includes:
a position detector that detects a position of the sample in a direction in which the sample faces a side wall of the cassette;
a hardware processor that controls the conveyor;
wherein when the position of a center of gravity of the one of the plurality of samples is not within a specified value range from a detection result of the position detector, the hardware processor controls the conveyor to perform an operation of moving a position at which the conveyor holds the one of the plurality of samples close to the center of gravity of the one of the plurality of samples and then retrieving the one of the plurality of samples from the cassette.

4. The sample measuring apparatus according to claim 1,
wherein the contact avoidance section includes:
a position detector that detects a position of the sample in a direction in which the sample faces a side wall of the cassette;
a hardware processor that controls the conveyor;
wherein when the one of the plurality of samples and the side wall of the cassette are in contact with each other from a detection result of the position detector, the hardware processor controls the conveyor to move the one of the plurality of samples held by the conveyor in a direction away from the side wall of the cassette and then take out the sample from the cassette, and when the position of a center of gravity of the one of the plurality of samples is not within a specified value range from a detection result of the position detector, the hardware processor controls the conveyor to perform an operation of moving a position at which the conveyor holds the one of the plurality of samples close to the center of gravity of the one of the plurality of samples and then retrieving the one of the plurality of samples from the cassette.

5. The sample measuring apparatus according to claim 1,
wherein the contact avoidance section is a recessed part formed at an end on a side of the side wall of the cassette in a support portion that supports the plurality of samples of the cassette.
